(19) United States
(12) Patent Application Publication
(10) Pub. No.: US 2016/0241903 A1
(43) Pub. Date: Aug. 18, 2016

(54) IMAGE OUTPUT APPARATUS

(71) Applicant: LG ELECTRONICS INC., Seoul (KR)

(72) Inventor: Jinhwa EUN, Seoul (KR)

(73) Assignee: LG ELECTRONICS INC., Seoul (KR)

(21) Appl. No.: 14/915,798

(22) PCT Filed: Oct. 23, 2014
(86) PCT No.: PCT/KR2014/010014

§ 371 Date: Mar. 1, 2016

(30) Foreign Application Priority Data
Oct. 23, 2013 (KR) 10-2013-0126728

(51) Int. Cl. H04N 21/431; H04N 21/434

(52) U.S. Cl. CPC H04N 21/4312; H04N 21/4345

(57) ABSTRACT

An image output apparatus is disclosed, which is capable of three-dimensionally providing, along with a basic EPG, additional EPGs for delivering data related to an item selected from the basic EPG.

### TECHNICAL FIELD

The present invention relates to an image output apparatus, and more particularly, to an image output apparatus that provides, along with a basic EPG, additional EPGs for an item selected from the basic EPG.

### BACKGROUND ART

Nowadays, a wide variety of electronic program guides (EPGs) such as digital broadcast channel information, broadcast programming information, etc. are available through networks. It is expected that, over the coming years, the amount of content people can watch on smart TVs will grow exponentially.

One of the major issues in this age of information overflow is to allow users to find an EPG they want and learn easily how to use it.

Because current EPGs are presented in simple, two-dimensional form, they can provide only a limited amount of on-screen information. Moreover, if an EPG has a large volume of data, it is not easy for the user to acquire information easily and intuitively and select the content they want.

### DISCLOSURE

### Technical Problem

One technical object of the present invention is directed to providing an image output apparatus that creates additional EPGs by performing a search about an item selected from a basic EPG and provides them along with the basic EPG. Another technical object of the present invention is to provide an image output apparatus that provides intuitive information and a selection function by three-dimensionally displaying the basic EPG and the additional EPGs.

It is to be understood that technical objects to be achieved by the present invention are not limited to the aforementioned technical objects and other technical objects which are not mentioned herein will be apparent from the following description to a person of ordinary skill in the art to which the present invention pertains.

### Technical Solution

An exemplary embodiment of the present invention provides an image output apparatus including: a communication unit configured to receive service information according to a prescribed protocol; a display unit; and a controller.

The controller may be configured to control the display unit to extract a basic electronic program guide (EPG) contained in the received service information and display the same in a basic layer. In this case, the controller may be configured to, when a particular item is selected from the basic EPG displayed in the basic layer, search for data related to the particular item on a network, create a plurality of additional EPG groups based on found data, and configure a plurality of additional layers with different depths corresponding to the plurality of additional EPG groups, and may be configured to control the display unit to display the plurality of additional EPG groups in the corresponding additional layers, out of the plurality of additional layers, while the basic EPG is being displayed in the basic layer.

The particular item may correspond to a currently available particular broadcast program, and the plurality of additional EPG groups may include at least one among an EPG group corresponding to catch-up broadcasts of the particular broadcast program, an EPG group corresponding to videos related to the particular broadcast program, and an EPG group corresponding to articles related to the particular broadcast program.

The controller may be configured to specify additional layers corresponding to the plurality of additional EPG groups, out of the plurality of additional layers, according to preset priorities.

The image output apparatus may further include a user input unit. In this case, the controller may be configured to change the layers displaying the basic EPG and the plurality of additional EPG groups, based on a control signal received through an external input means that operates in conjunction with the image output apparatus through the user input unit and the communication unit.

The controller may be configured to, when a particular additional EPG group is selected from among the plurality of additional EPG groups, display the particular additional EPG group in the basic layer based on the control signal.

The controller may be configured to, when a particular additional EPG group is selected from among the plurality of additional EPG groups, expand the display area of the particular additional EPG group within the layer specified for the particular additional EPG group and additionally display data corresponding to the particular additional EPG group in the expanded display area of the particular additional EPG group.

The controller may be configured to select a particular additional EPG group from among the plurality of additional EPG groups, based on a first control signal generated by operating the user input unit and the external input means, and to change the layer displaying the particular additional EPG group based on a second control signal generated by operating the user input unit and the external input means.

Another exemplary embodiment of the present invention provides a method for operating an image; output apparatus, the method including: receiving service information according to a prescribed protocol; extracting a basic electronic program guide (EPG) contained in the received service information and displaying the same in a basic layer; when a particular item is selected from the basic EPG displayed in the basic layer, searching for data related to the particular item on a network, creating a plurality of additional EPG groups based on found data, and configuring a plurality of additional layers with different depths corresponding to the plurality of additional EPG groups; and controlling the display unit to display the plurality of additional EPG groups in the corresponding additional layers, out of the plurality of additional layers, while the basic EPG is being displayed in the basic layer.

The particular item may correspond to a currently available particular broadcast program, and the plurality of additional EPG groups may include at least one among an EPG group corresponding to catch-up broadcasts of the particular broadcast program, an EPG group corresponding to videos related to the particular broadcast program, and an EPG group corresponding to articles related to the particular broadcast program.

The image output apparatus operating method may include specifying additional layers corresponding to the plurality of additional EPG groups, out of the plurality of additional layers, according to preset priorities. The image output apparatus may further include a user input unit. In this case, the layers displaying the basic EPG and the plurality of additional EPG groups may be changed, based on a control signal received through an external input means that operates in conjunction with the image output apparatus through the user input unit and the communication unit.

### Advantageous Effects

An image output apparatus according to the present invention offers the advantage of providing, along with a basic EPG, additional EPGs for data related to an item selected from the basic EPG.

Furthermore, the image output apparatus according to the present invention offers the advantage of providing an intuitive user interface environment by three-dimensionally displaying the basic EPG and the additional EPGs.

### BRIEF DESCRIPTION OF THE DRAWINGS

FIG. 1 is a block diagram of an image output apparatus according to the present invention.

FIG. 2 is a flowchart illustrating an example of a method for operating an image output apparatus according to the present invention.

FIG. 3 is a drawing conceptually illustrating an implementation procedure for the image output apparatus operating method of FIG. 2.

FIG. 4 illustrates an example of a three-dimensional EPG created by an image output apparatus according to the present invention.

FIG. 5 illustrates an example of a three-dimensional EPG provided by the image output apparatus according to the present invention.

FIGS. 6 and 7 illustrate an example of displaying a plurality of additional EPG groups by the image output apparatus according to the present invention.

FIGS. 8 to 12 illustrate examples of changes made by the user to the display format of a three-dimensional EPG on the image output apparatus 100 according to the present invention.

### BEST MODE FOR THE INVENTION

The foregoing objects, features, and advantages of the present invention may be apparent from the following detailed description taken in conjunction with the accompanying drawings. Hereinafter, preferred embodiments of the present invention will be described with reference to the drawings. The same reference numerals are used to denote the same elements throughout the specification.

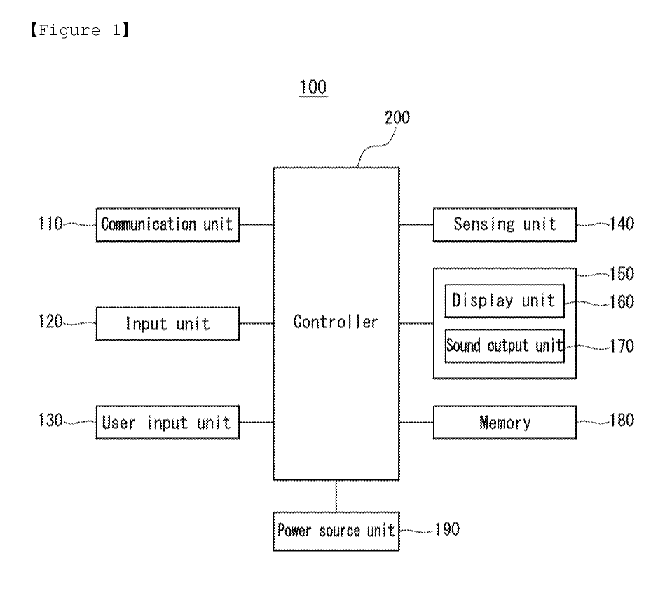

FIG. 1 is a block diagram illustrating an image output apparatus 100 according to an embodiment of the present invention. The image output apparatus described herein may include a TV, a PC, a digital signage device, etc. However, the scope of the present invention is not limited thereto.

Referring to FIG. 1, the image output apparatus 100 includes a communication unit 110, an input unit 120, a user input unit 130, a sensing unit 140, an output unit 150, a memory 180, a power source unit 190, and a controller 200. The image output apparatus 100 may include more or less components than those shown in FIG. 1.

The communication unit 110 may include one or more modules that enable wired/wireless communication between the image output apparatus 100 and a communication network. For example, the communication unit 110 may include a broadcast receiving module, a mobile communication module, a wireless Internet module, and a near-field communication module. The communication unit 110 may receive a broadcast signal through the communication network.

The input unit 120 is the component for obtaining an audio signal or video signal input from an outside source, and as shown in FIG. 1, may include a camera 121 and a microphone 122. The camera 121 processes an image frame such as a still image or motion image obtained by an image sensor in a video call mode or image capturing mode. Further, the microphone 122 receives an external voice signal and processes it into electrical voice data.

In addition, the user input unit 130 generates input data for a user to control the operation of the image output apparatus 100. The user input unit 130 may include a key pad, a dome switch, a touchpad (resistive/capacitive), a jog wheel, a jog switch, etc.

The sensing unit 140 can sense the current state of the image output apparatus 100 or the user's state and sense an ambient environment state of the image output apparatus 100. The data sensed by the sensing, unit 140 may be used for controlling the operation of the image output apparatus 100.

The output unit 150 can output an image signal and a video signal of content reproduced under the control of the controller 200. As shown in FIG. 1, the output unit 150 may include a display unit 160 and a sound output unit 170.

In addition, the display unit 160 displays and outputs the information processed by the image output apparatus 100. The display unit 160 may be implemented as-a liquid crystal display, a thin film transistor-liquid crystal display, an organic light emitting diode display, or a flexible display. The display unit 160 may include a display outputting images and a polarized film filtering an image with a predetermined polarized angle and outputting it.

Further, the display unit 160 can output an image according to a polarized glasses scheme or a shutter-glass scheme in order for the user to recognize a 3D stereoscopic image. However, the schemes for implementing 3D stereoscopic images are not limited to the above examples.

In addition, the sound output unit 170 outputs a sound signal associated with a function performed by the image output apparatus 100. Such sound output unit 170 may include a receiver, a speaker, a buzzer, etc. Further, the sound output unit 170 may output a sound through an earphone jack.

The memory 180 can store a program for the operation of the controller 200 and temporarily or permanently retain input/output data. The memory 180 can also temporarily or permanently store image data output through the display unit 160 and sound data corresponding thereto.

The memory 180 may include at least one-type storage medium of a flash-type memory, a hard disc-type memory, a multimedia card micro-type memory, a card-type memory (e.g., an SD or XD memory), a RAM (Random Access Memory), an SRAM (Static Random Access Memory), a ROM (Read-Only Memory), an EEPROM (Electrically Erasable Programmable Read-Only Memory), a PROM (Programmable Read-only Memory), a magnetic memory, a magnetic disc, and an optical disc. The image output apparatus 100 may be operated in association with a web storage performing the storage function of the memory 180 over the Internet.

In addition, the controller 200 generally controls the overall operation of the image output apparatus 100. That is, the controller 200 can control the operation of each component of the image output apparatus 100. The controller 200 may also include a plurality of sub control units for performing specified functions, respectively.

In addition, the power source unit 190 can receive internal or external power under the control of the controller 200 and supply power used for operating the components.

Various embodiments as described herein may be implemented in a recording medium that may be read by a computer or a similar device using, e.g., software, hardware, or combinations thereof. When implemented in hardware, the embodiments described herein may be realized using at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, micro-controllers, micro-processors, and electrical units for performing the functions. In some cases, such embodiments may be implemented by the controller 200.

When implemented in software, the embodiments such as procedures or functions may be realized alongside a separate software module that enables at least one function or operation. The software codes may be implemented by a software application written in a proper programming language. Further, the software codes may be stored in the memory 180 and may be executed by the controller 200.

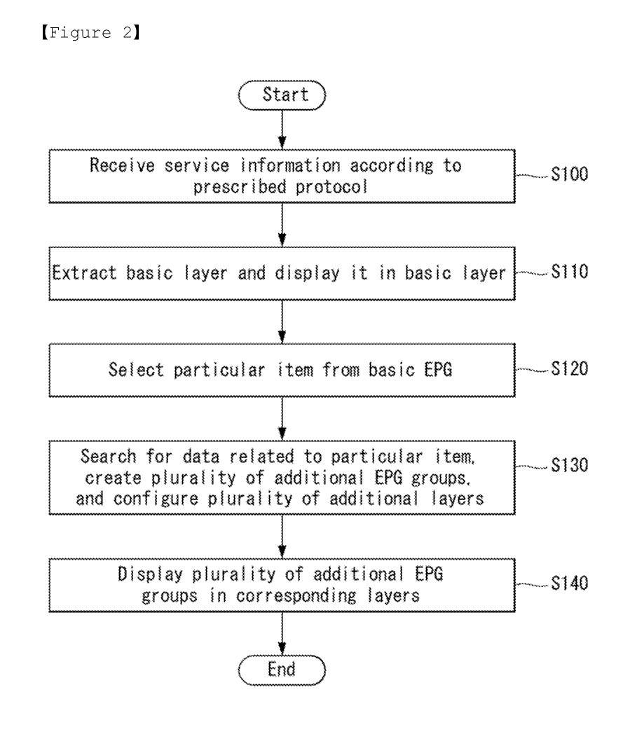

FIG. 2 is a flowchart illustrating an example of a method for operating an image output apparatus according to the present invention. Hereinafter, the operating method will be described with reference to the necessary drawings.

First of all, service information is received through the communication unit 110 according to a prescribed protocol (S100). The prescribed protocol may be the Program and Service Information Protocol (PSIP) or a Digital Video Broadcasting-Service Information (DVB-SI)-based protocol. However, the scope of the present invention is not limited to them.

Upon receiving the service information, the controller 200 of the image output apparatus 100 extracts a basic EPG from the service information and displays the extracted EPG in a basic layer (S110). Here, the basic EPG information may be about currently available broadcast programs or about a VOD service provided by a particular service server.

The basic layer is a virtual layer corresponding to a reference depth. Here, the reference depth refers to the depth by which the depth of an additional layer to be described later can be determined.

Next, a particular item is selected from the basic EPG displayed in the basic layer (S120). The selection of the particular item may be made by the user's operation using an external input means that operates in conjunction with the image output apparatus 100 through the communication unit 110. The external input means may include a remote control, a mouse, etc. However, the scope of the present invention is not limited to them. Also, if the display unit 160 supports a touch screen function, the selection of the particular item may be made by the user's touch on the particular item.

When the particular item is selected, the controller 200 searches for data related to the particular item, creates a plurality of additional EPG groups based on found data, and configures a plurality of additional layers corresponding to the plurality of additional EPG groups (S130). The additional layers may correspond to different depths.

Here, the search for data related to the particular item may be performed in the memory 180 included in the image output apparatus 110. Also, the search for data related to the particular item may be performed on a network connected through the communication unit 110.

Standards for creating a plurality of additional EPG groups may be preset based on the found data. These standards may be preset by the user. Also, the preset standards may be changed by the user.

The plurality of layers may have different depths. The plurality of layers may be deeper than the basic layer. That is, the controller 200 may configure the plurality of layers in such a manner that the plurality of additional EPGs look more distant than the basic EPG. Each of the plurality of layers may correspond to one of the plurality of additional EPG groups.

Referring again to FIG. 2, the controller 200 displays each of the plurality of additional EPG groups in the corresponding additional layer, out of the plurality of additional layers (S140). Since the plurality of additional layers correspond to different depths, the user may visually perceive that the plurality of EPGs are arranged in a three-dimensional space. In this specification, such an EPG, which is perceived to be arranged in a three-dimensional space, is called a three-dimensional EPG.

In this instance, the basic EPG may remain displayed in the basic layer. Then, the three-dimensional EPG may refer to an EPG including the basic EPG and the plurality of additional EPGs.

That is, the basic EPG may be perceived as closest to the user, whereas the plurality of additional EPGs may be perceived as increasingly distanced from the user as their number goes up. The order in which the plurality of additional EPGs are arranged may be determined according to preset priorities.

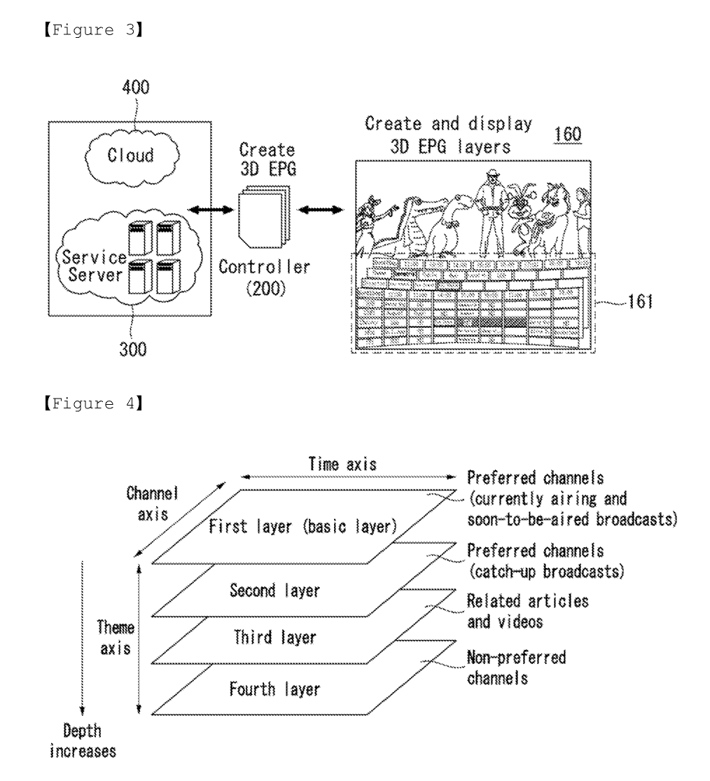

FIG. 3 is a drawing conceptually illustrating an implementation procedure for the image output apparatus operating method of FIG. 2.

Referring to FIG. 3, it can be seen that the image output apparatus 100 according to the present invention receives service information from a cloud space 400 or service server 300 that provides VOD service or broadcast content, creates a three-dimensional EPG based on the received service information, and matches the created three-dimensional EPG 161 to a plurality of layers with different depths and displays it on the display unit 160.

FIG. 4 illustrates an example of a three-dimensional EPG created by an image output apparatus according to the present invention.

Referring to FIG. 4, a plurality of EPG groups may be displayed in a plurality of layers with different depths. For the arrangement of the plurality of EPG groups, the horizontal direction may correspond to a time axis, the vertical direction may correspond to a channel axis, and the depth direction may correspond to a theme axis.

First of all, the first layer is assigned to the viewer's preferred channels. The first layer is a basic layer, and may have the same depth as the surface of the display unit 160. In the first layer, a basic EPG corresponding to what is currently airing or soon to be aired on the viewer's preferred channels may be displayed. The basic EPG displayed in the basic layer may be extracted from service information received from the outside.

The second layer is assigned to an additional EPG group for catch-up broadcasts, which is the user's second preferred theme. The third layer is assigned to an additional EPG group corresponding to articles or videos related to an item selected from the basic EPG, and the fourth layer is assigned to an additional EPG group corresponding to the viewer's non-preferred channels.

The controller 200 of the image output apparatus 100 may search for data corresponding to the catch-up broadcasts by using part of the service information as a keyword and create an additional EPG group corresponding to the catch-up broadcasts based on search results.

The controller 200 may search for the related articles and videos to be displayed in the third layer, based on the keyword contained in the service information, and then create an additional EPG group based on search results. Also, the controller 200 may search for data corresponding to the non-preferred channels based on the keyword contained in the service information and create an additional EPG group corresponding to the non-preferred channels based on search results.

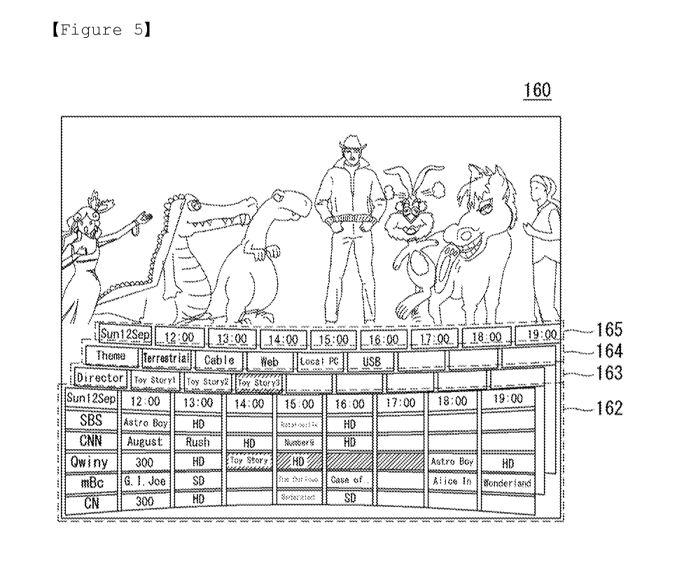

FIG. 5 illustrates an example of a three-dimensional EPG provided by the image output apparatus 100 according to the present invention.

It can be seen that a basic EPG 162 presenting currently available broadcast channels and their broadcast schedules is displayed in a basic layer (i.e., first layer) with a depth corresponding to the surface of the display unit 160. In this instance, the basic EPG 162 may be extracted from service information received through the communication unit 110. Also, it can be seen that an item corresponding to “Toy Story” has been selected from the basic EPG 162.

In a second layer that looks more distant (i.e., deeper) from the user than the basic layer, an additional EPG group 163 corresponding to catch-up broadcasts of “Toy Story” is displayed based on the selection of the item corresponding to “Toy Story” from the basic EPG 162. In this case, the additional EPG group 163 may be created based on data the controller 200 has found by performing a data search on a network connected through the communication unit 110. Also, the additional EPG group 163 may be created based on the data the controller 200 has found in the memory 180 equipped in the image output apparatus 100.

In a third layer that looks more distant (i.e., deeper) from the user than the second layer, an additional EPG group 164 corresponding to videos or articles related to “Toy Story” is displayed based on the selection of the item related to “Toy Story” from the basic EPG 162. In this instance, the additional EPG group 164 may be created based on the data found on a network the image output apparatus 100 is connected to, or may be created based on data found in the memory 180. Needless to say, such a data search may be performed based on the selection of the item corresponding to “Toy Story” from the basic EPG group 162.

In a fourth layer that looks more distant (i.e., deeper) from the user than the third layer, an additional EPG group 165 corresponding non-preferred channels is displayed. These non-preferred channels may be set by the user, or may be automatically created by the controller 200 of the image output apparatus 100.

Meanwhile, an image of “Toy Story” is being displayed in a fifth layer, which is the deepest layer.

The additional EPG groups illustrated in FIG. 5 is merely an example given in accordance with an embodiment of the present invention, and therefore the scope of the present invention is not limited to it. Furthermore, the user may specify additional EPG groups or change them.

Moreover, the plurality of additional EPG groups may be displayed in their corresponding layers according to preset priorities. The order in which the plurality of additional EPG groups are arranged (i.e., the corresponding layers or the depths at which the plurality of additional EPG groups are displayed) also may be set and changed by the user.

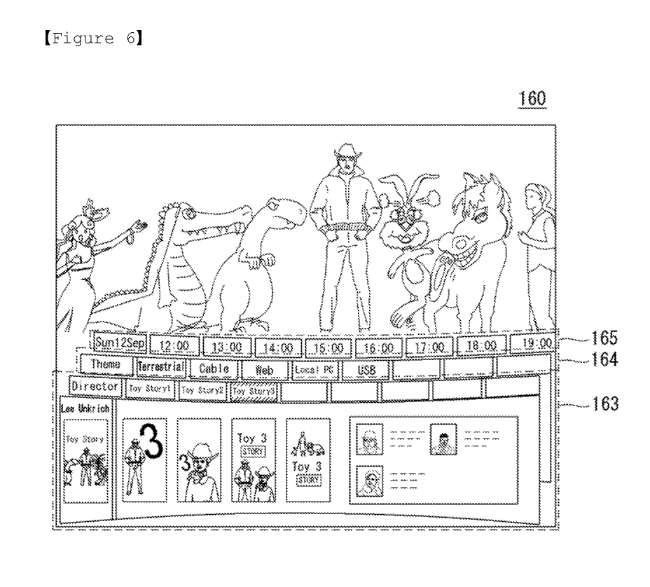

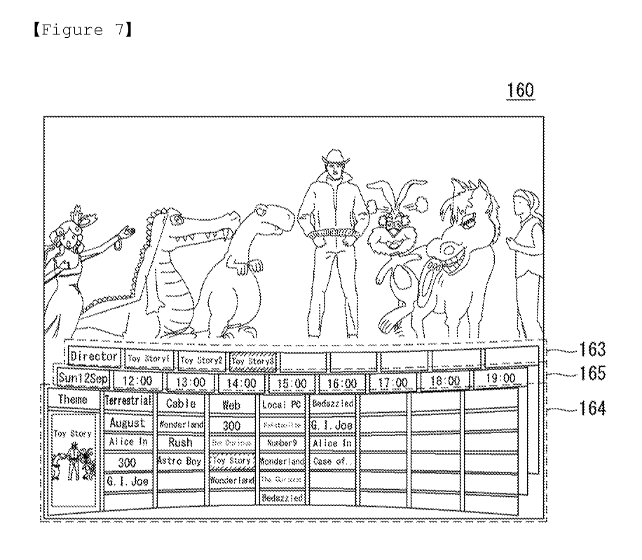

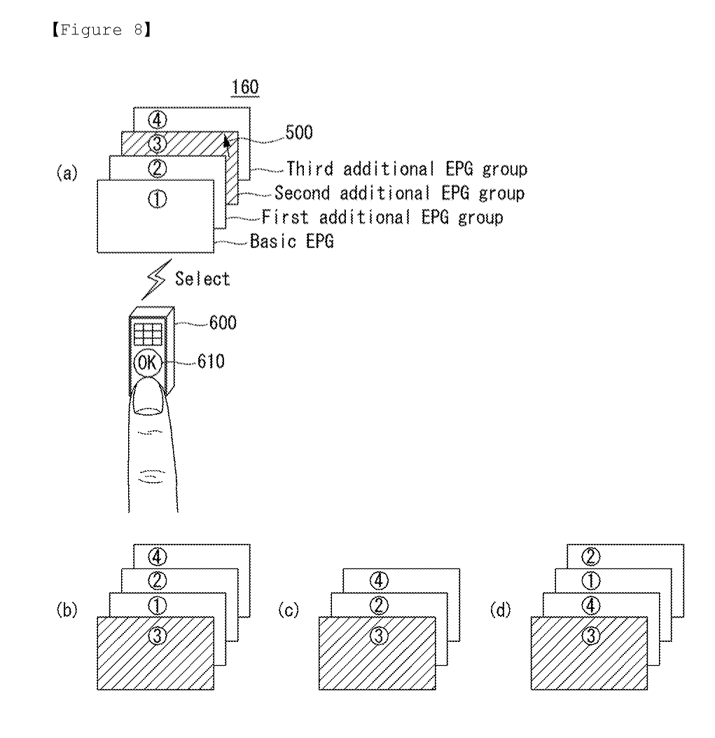

FIGS. 6 and 7 illustrate an example of displaying a plurality of additional EPG groups by the image output apparatus 100 according to the present invention. For reference, the examples shown in FIGS. 6 and 7 may be modifications of the example shown in FIG. 5, with some change in their display format.

Referring to FIG. 6, the additional EPG group 163 corresponding to the catch-up broadcasts of “Toy Story”, which is displayed in the second layer in FIG. 5, is displayed in the basic layer with the same depth as the surface of the display unit 160. Also, the additional EPG group 163 is larger in display area than that shown in FIG. 5, which enables display of thumbnail images corresponding to the catch-up broadcasts.

The additional EPG group 164 corresponding to the articles or videos related to “Toy Story” may be displayed in the second layer, and the additional EPG group 165 corresponding to the non-preferred channels may be displayed in the third layer.

Referring to FIG. 7, the additional EPG group 164 corresponding to the articles or videos related to “Toy Story” is displayed in the basic layer, the additional EPG group 165 corresponding to the non-preferred channels is displayed in the third layer, and the additional EPG group 163 corresponding to the catch-up broadcasts of “Toy Story” is displayed in the third layer.

The display status of the EPG groups shown in FIG. 7 may be a change from that shown in FIG. 6 or a change from that shown in FIG. 5.

The above-de scribed changes in the display layers of the basic EPG and additional EPG groups may be made based on a control signal that is generated by operating the user input unit 130 of the image output apparatus 100, touching the display unit 160 serving as a touchscreen, and operating an external input means connected with wires or wirelessly to the communication unit 110 and operating in conjunction with the image output apparatus 100. Here, the external input means may include a remote control, mouse, etc., but the scope of the present invention is not limited to them.

FIGS. 8 to 12 illustrate examples of changes made by the user to the display format of a three-dimensional EPG on the image output apparatus 100 according to the present invention.

(a) of FIG. 8 illustrates a three-dimensional EPG including a basic EPG, with first, second, and third additional EPG groups being displayed in their corresponding layers, out of a plurality of layers. Also, (a) of Fig, 8 illustrates that the user is selecting the second additional EPG group by pressing a confirm button 610 of a remote control 600. For reference, the circled numbers 1, 2, 3, and 4 shown in FIGS. 8 to 12 represent the basic EPG, first additional EPG group, second additional EPG group, and third additional EPG group, respectively.

When the user operates the remote control as shown in (a) of FIG. 8, the controller 200 of the image output apparatus 100 may display the second additional EPG group in the basic layer and then sequentially display the basic EPG, first additional EPG group, and third additional EPG group, as illustrated in (b) of FIG. 8.

When the user operates the remote control as shown in (a) of FIG. 8, the controller 200 of the image output apparatus 100 may display the second additional EPG group in the basic layer and then sequentially display the first additional EPG group and the third additional EPG group, but not the basic EPG, as illustrated in (c) of FIG. 8.

When the user operates the remote control as shown in (a) of FIG. 8, the controller 200 of the image output apparatus 100 may display the second additional EPG group in the basic layer and then sequentially display the third additional EPG group, basic EPG, and first additional EPG group, as illustrated in (d) of FIG. 8.

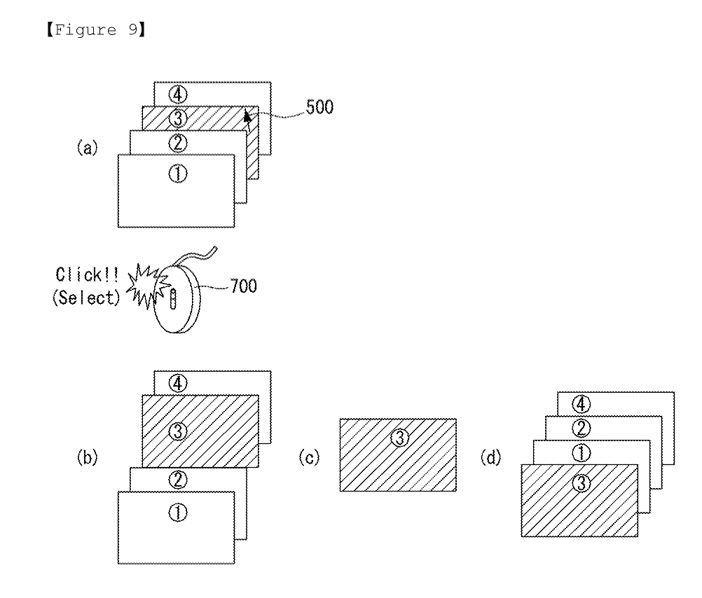

The user may select the second additional EPG group by clicking a mouse 700 connected to the image output apparatus 100, as illustrated in (a) of FIG. 9. Then, the controller 200 may expand the display area of the second additional EPG group, without changing the layer displaying the second additional EPG group, as illustrated in (b) of FIG. 9.

In this case, the controller 200 may increase the amount of information corresponding to the second additional EPG group displayed in the expanded area. That is, the controller 200 may additionally display data corresponding to the second additional EPG group in the expanded display area of the second additional EPG group.

The controller 200 may display the third additional EPG group in a deeper layer than the second additional EPG group, as illustrated, in (a) of FIG. 9.

Alternatively, when the user selects the second additional EPG group, by clicking the mouse 700 connected to the image output apparatus 100, as illustrated in (a) of FIG. 9, the controller 200 may provide only the second additional EPG group, as illustrated in (c) of FIG. 9.

Alternatively, when the user selects the second additional EPG group by clicking the mouse 700 connected to the image output apparatus 100, as illustrated in (a) of FIG. 9, the controller 200 may display the second additional EPG group in the basic layer and then sequentially display the basic EPG, first additional EPG group, and third additional EPG group.

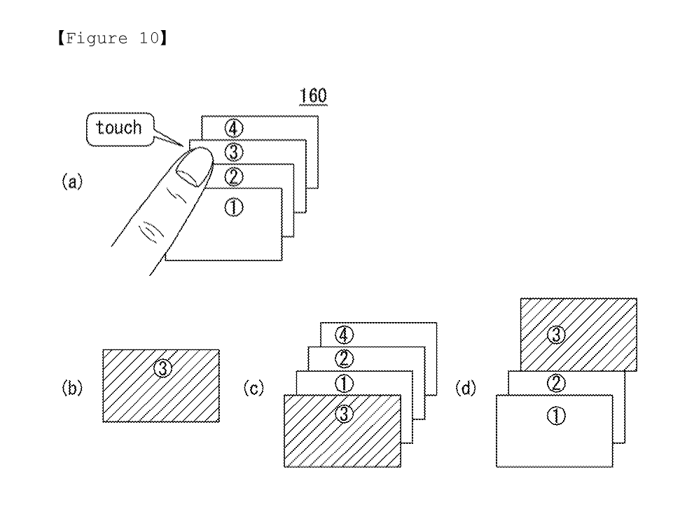

(a) of FIG. 10 illustrates that the user selects the second additional EPG group by touching it, in a case where the display unit 160 supports a touchscreen function. Then, the controller 200 may display only the second additional EPG group in the basic layer, as illustrated in (b) of FIG. 10. Also, the controller 200 may display the second additional EPG group in the basic layer and then sequentially display the basic EPG, first additional EPG group, and third additional EPG group; as illustrated in (c) of FIG. 10.

Also, the controller 200 may display the second additional EPG group in the layer where it was originally displayed and expand the display area, as illustrated in (d) of FIG. 10. The third additional EPG group shown in (d) of FIG. 10 is not displayed on the display unit 160, unlike in (b) of FIG. 9.

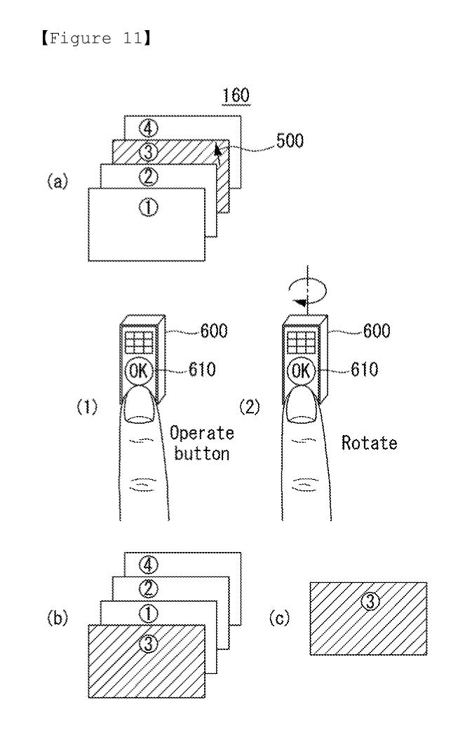

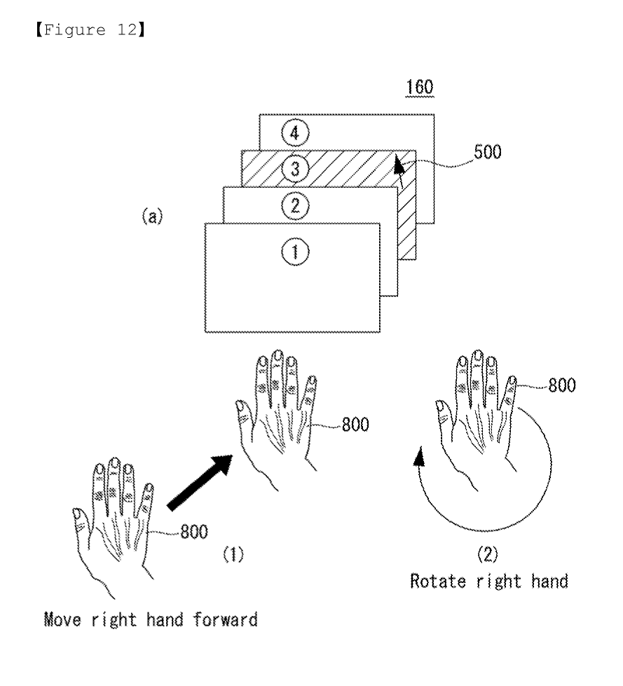

(a) of FIG. 11 illustrates that, with a cursor 500 positioned on the second additional EPG group, the user is rotating the remote control 600 clockwise while pressing . the confirm button 610 of the remote control 600. Then, the controller 200 may select the, second additional EPG group based on a first control signal generated by the pressing of the button 610, and change the display status of the three-dimensional EPG based on a control signal generated by the rotation.

That is, as illustrated in (b) and (c) of FIG. 11, the controller 200 may change the display position of the second additional EPG group to the basic layer, or display only the second additional EPG group on the display unit 160.

FIG. 12 illustrates that the controller 200 may select the second additional EPG group based on a control signal generated by the user's gesture of moving the right hand 800 forward and change the layer displaying the second additional EPG group based on a control signal generated by the user's gesture of rotating the right hand 800.

The above-described method for operating an image output apparatus according to the present invention may be implemented in the form of a program that can be executed by a variety of computer means and recorded in a computer-readable medium. The computer-readable medium may include, alone or in combination, program instructions, data files, a data structure, etc. The program instructions recorded in the computer-readable medium may be specially designed and constructed for the present invention, or be well known to those skilled in the field of computer software.

Examples of computer-readable media include: magnetic media such as hard disks, floppy disks, and magnetic tape; optical media such as CD-ROM and DVD; magneto-optical media such as floptical disks; and hardware devices that are specially configured to store and perform program instructions, such as read-only memory (ROM), random access memory (RAM), flash memory, etc. Examples of program instructions include machine code, such as produced by a compiler, and high-level language code that can be executed by the computer using an interpreter or the like. The hardware devices may be configured to act as one or more software modules for performing the operation of the present invention, and vice versa.

Although only a few embodiments of the present invention have been shown and described, the present invention is not limited to the described embodiments. Instead, it would be appreciated by those skilled in the art that various modifications and changes can be made to these embodiments without departing from the principles and spirit of the invention.

Therefore, the scope of the present invention should not be limited by the above-described embodiment, but rather defined by the following claims and their equivalents.

### INDUSTRIAL APPLICABILITY

### Sequence List Text

| | | | |
|---|---|---|---|
| 100: | image output apparatus | | |
| 110: | communication unit | | |
| 120: | input unit | 130: | user input unit |
| 140: | sensing unit | 150: | output unit |
| 160: | display unit | 170: | sound output unit |
| 180: | memory | 190: | power source unit |
| 200: | controller | 300: | service server |
| 400: | cloud space | 500: | cursor |
| 600: | remote control | 700: | mouse |

1. An image output apparatus comprising:
a communication unit configured to receive service information according to a prescribed protocol
a display unit; and
a controller configured to:
extract a basic electronic program guide (EPG) contained in the received service information and control the display unit to display the extracted basic EPG in a basic layer,
when a particular item is selected from the basic EPG displayed in the basic layer, search for data related to the particular item on a network, create a plurality of additional EPG groups based on found data, and configure a plurality of additional layers with different depths corresponding to the plurality of additional EPG groups, and
control the display unit to display the plurality of additional EPG groups in the corresponding additional layers among the plurality of additional layers, while the basic EPG is being displayed in the basic layer.

2. The image output apparatus of claim 1, wherein the particular item corresponds to a currently available particular broadcast program, and
wherein the plurality of additional EPG groups comprise at least one among an EPG group corresponding to catch-up broadcasts of the particular broadcast program, an EPG group corresponding to videos related to the particular broadcast program, and an EPG group corresponding to articles related to the particular broadcast program.

3. The image output apparatus of claim 1, wherein the controller is configured to specify additional layers corresponding to the plurality of additional EPG groups, among the plurality of additional layers, according to preset priorities.

4. The image output apparatus of claim 1, further comprising a user input unit,
wherein the controller is configured to change the layers displaying the basic EPG and the plurality of additional EPG groups, based on a control signal received through an external input means that operates in conjunction with the image output apparatus through the user input unit and the communication unit.

5. The image output apparatus of claim 4, wherein, the controller is configured to, when a particular additional EPG group is selected from among the plurality of additional EPG groups, display the particular additional EPG group in the basic layer based on the control signal.

6. The image output apparatus of claim 4, wherein the controller is configured to, when a particular additional EPG group is selected from among the plurality of additional EPG groups, expand the display area of the particular additional EPG group within the layer specified for the particular additional EPG group and additionally display data corresponding to the particular additional EPG group in the expanded display area of the particular additional EPG group.

7. The image output apparatus of claim 4, wherein the controller is configured to:
select a particular additional EPG group from among the plurality of additional EPG groups, based on a first control signal generated by operating the user input unit and the external input means, and
change the layer displaying the particular additional EPG group based on a second control signal generated by operating the user input unit and the external input means.

8. A method for operating an image output apparatus, the method comprising:
receiving service information according to a prescribed protocol;
extracting a basic electronic program guide (EPG) contained in the received service information and displaying the same in a basic layer;
when a particular item is selected from the basic EPG displayed in the basic layer, searching for data related to the particular item on a network, creating a plurality of additional EPG groups based on found data, and configuring a plurality of additional layers with different depths corresponding to the plurality of additional EPG groups; and
controlling the display unit to display the plurality of additional EPG groups in the corresponding additional layers, among the plurality of additional layers, while the basic EPG is being displayed in the basic layer.

9. The method of claim 8, wherein the particular item corresponds to a currently available particular broadcast program, and
wherein the plurality of additional EPG groups comprise at least one among an EPG group corresponding to catch-up broadcasts of the particular broadcast program, an EPG group corresponding to videos related to the particular broadcast program, and an EPG group corresponding to articles related to the particular broadcast program.

10. The method of claim 8, further comprising operating an image output apparatus may include specifying additional layers corresponding to the plurality of additional EPG groups, among the plurality of additional layers, according to preset priorities.

11. The method of claim 8, wherein the image output apparatus further comprises a user input unit,
wherein the layers displaying the basic EPG and the plurality of additional EPG groups are changed, based on a control signal received through an external input means that operates in conjunction with the image output apparatus through the user input unit and the communication unit.
